(19) United States
(12) Patent Application Publication
(10) Pub. No.: US 2006/0011875 A1
(43) Pub. Date: Jan. 19, 2006

(54) Hydraulically controlled valve comprising at least one hydraulic drive unit

(76) Inventors: Josef Zurcher, Neuheim (CH); Hansruedi Brand, Huenenberg (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/533,213

(22) PCT Filed: Aug. 10, 2004
(86) PCT No.: PCT/CH04/00498

§ 371 Date: Apr. 28, 2005

(30) Foreign Application Priority Data
Aug. 27, 2003 (CH) 1465/03

(51) Int. Cl. F16K 31/143

(52) U.S. Cl. 251/63.6

(57) ABSTRACT

A hydraulically controlled valve includes at lease one hydraulic drive unit that is provided with a control piston to which a control tappet is connected. The control tappet acts upon a flow control mechanism of the valve for controlling the flow of hydraulic oil from or to a consumer. The control piston can be moved towards a control spring by a control pressure P_{X}. The control piston has a first step and a second step which have different diameters. A connection having a throttle point is provided between a primary control pressure chamber and a secondary control pressure chamber. The valve creates a throttle effect with the aid of which vibrations are dampened.

The invention pertains to a hydraulically controlled valve with at least one hydraulic drive according to the introductory clause of claim 1.

A load-holding brake valve which can be controlled by a hydraulic drive is known from WO 97/32136 A1. The main piston of the load-holding brake valve is actuated by the plunger of a control piston. A control pressure moves this control piston against the pressure of a control spring. These types of load-holding brake valves are suitable for driving double-acting hydraulic consumers, for example, which are subject to mechanical loads. Depending on the type of mechanical load, such devices tend to oscillate. Arrangements such as cranes with very long lift arms, for example, are known. As the result of an impact, for example, an oscillation can be caused, which causes the volume flow rate of the hydraulic oil to fluctuate. Oscillations can also originate in the hydraulic system itself, however, when the control of a movement is begun and/or a movement is accelerated or delayed. As a result of such oscillations, the speed of the hydraulic consumer is no longer constant, which means in turn that it becomes difficult or impossible to control such movements precisely.

A directional control valve which is suitable for driving double-acting hydraulic consumers is known from WO 02/075162 A1. It is disclosed here that the slider piston of the directional control valve can be moved by at least one drive. A solution with two hydraulic drives is shown. A drive piston which can be moved by a control pressure against a spring is provided in each of these drives. This drive piston can, for example, move the slider piston of the directional control valve by way of a piston rod. It is also possible for oscillation problems to occur in these types of arrangements.

A hydraulic, directly-controlled pressure-limiting valve of the sliding type is known from DE 24 31 785 A1. Because the differential piston which is present is controlled directly, this valve does not have a hydraulic drive.

A valve which can be used as a pressure-limiting valve is known from US 2,361,881 A. This valve does not have a hydraulic drive either.

A spring-loaded pressure relief valve, which also lacks a hydraulic drive, is known from DE-AS 1 254 925.

The invention is based on the task of creating a valve which is hydraulically controlled by at least one hydraulic drive and which is insensitive to both externally and internally induced oscillations without any impairment to the response sensitivity.

The task indicated above is accomplished according to the invention by the features of claim 1. Advantageous elaborations can be derived from the dependent claims.

Exemplary embodiments of the invention are explained in greater detail below on the basis of the drawing:

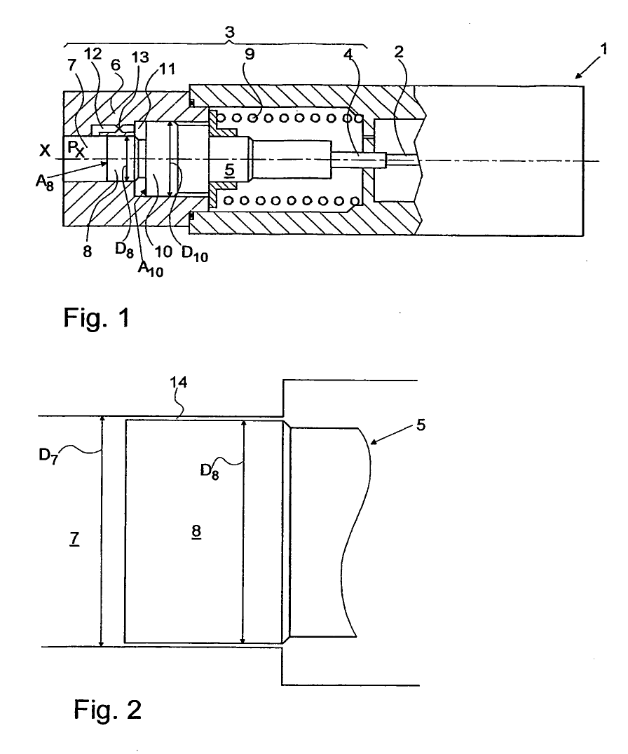

FIG. 1 shows a diagram of the details essential to the invention on the basis of an example of a load-holding brake valve;

FIG. 2 shows a diagram, not to scale, of a part of a control piston in a primary control pressure chamber;

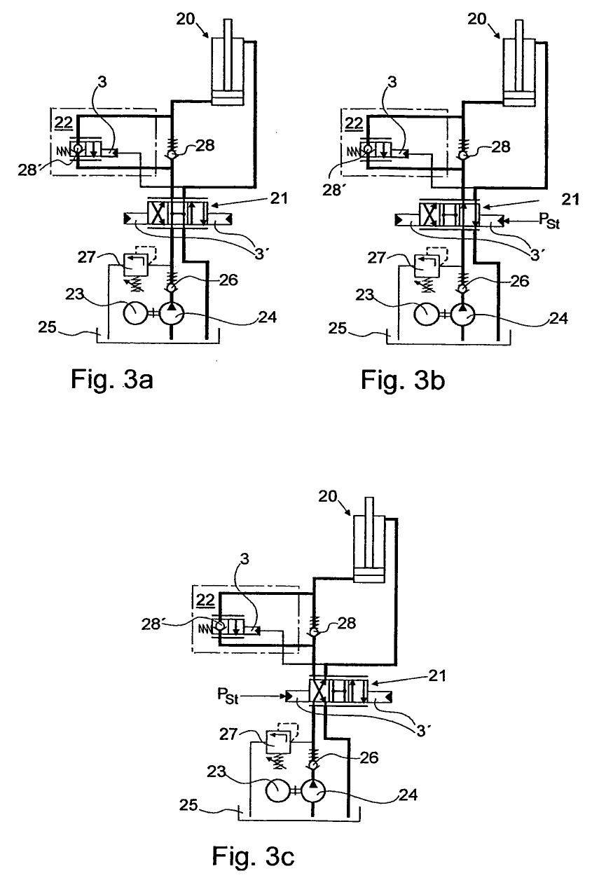

FIGS. 3a-3c show hydraulic diagrams of the various operating states of a consumer;

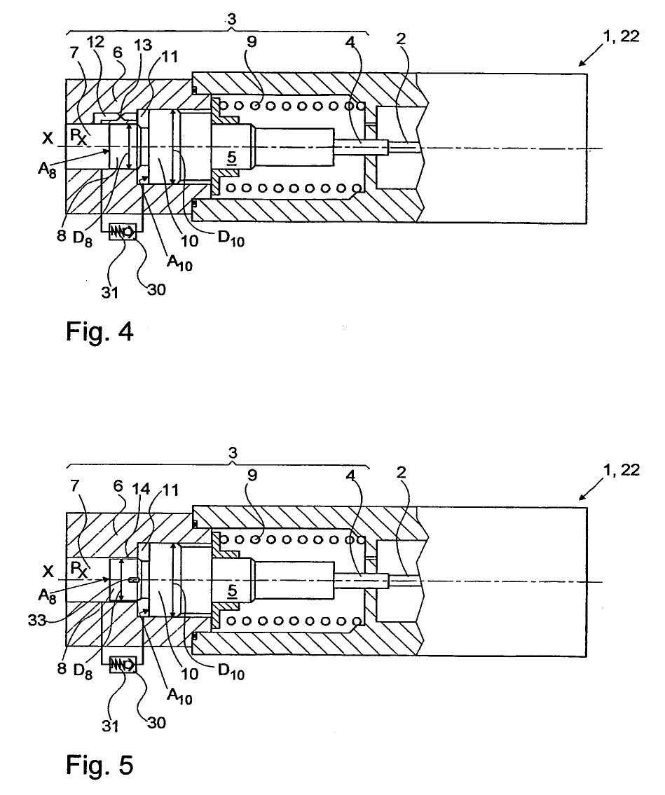

FIGS. 4 and 5 show advantageous embodiments of the drive of a load-holding brake valve; and

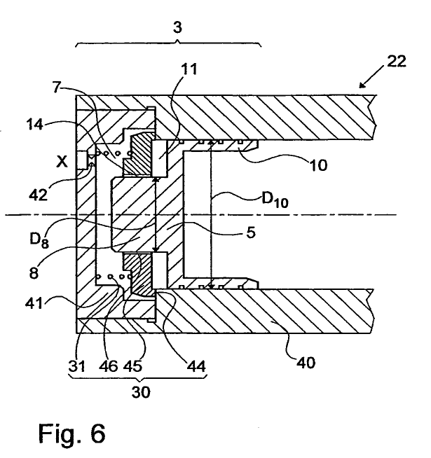

FIG. 6 shows an alternative advantageous embodiment.

In FIG. 1, which is a schematic diagram, 1 designates a hydraulically controlled valve, which, in this exemplary embodiment, is a load-holding brake valve. The view of this hydraulically controlled valve 1 in the form of a load-holding brake valve does not reveal any of the internal structure of the valve, since this internal structure is not essential to the invention and is known in and of itself from WO 97/32136 A1. Omitting a diagram of the internal structure is appropriate also because the parts of the hydraulically controlled valve 1 not essential to the invention could also be of a design completely different from that illustrated and described in WO 97/32136 A1. The invention is therefore independent of a specific design of the load-holding brake valve and thus completely independent of the design of the valve 1. The only essential point is that the valve 1 can be hydraulically controlled by at least one hydraulic drive and that the valve 1 has a flow-control device 2, by which the flow of hydraulic oil from and to a consumer can be controlled. This flow-control device 2 can be controlled by a hydraulic drive 3. The parts of this drive 3 essential to its function include a control plunger 4, which is part of a control piston 5, which acts on the flow-control device 2. If the valve 1 is a load-holding brake valve, also called a countertorque brake valve, the flow-control device 2 consists, for example, of a pilot valve and a main valve. If the valve 1 is of a different design, different parts will be present. In the case of a directional control valve according to WO 02/075162 A1, for example, the control plunger 4 acts directly on a slide piston.

A side view of the control piston 5 is shown. It is designed according to the invention as a stepped piston, the inventive features of which are described below. It should be mentioned beforehand, however, that a control pressure connection X is present in a housing part 6 on the left side of the valve 1. A bore, designated here the primary control pressure chamber 7, is provided in the housing part 6 at the control pressure connection X.

According to the invention, the control piston 5 has a first step 8 on the end facing the control pressure connection X; the diameter D₈ of this step is smaller than the inside diameter of the primary control pressure chamber 7 but only just enough to allow the piston to move. A control pressure P_{X}, which is present at the control pressure connection X and which therefore acts in the primary control pressure chamber 7, exerts a force F on the control piston 5. This force is equal to the product of the control pressure P_{X} and the end surface area A₈ of the first step 8, where the end surface area A₈ of the first step 8 is the product of half the diameter D₈ squared times a. The control pressure P_{X} therefore produces a force F by which the control piston 5 is pushed against a control spring 9. The distance which the control piston 5 travels therefore depends on the spring rate of the control spring 9.

According to the invention, the control piston 5 has a second step 10, the diameter D₁₀ of which is larger than the diameter D₈. The diameter D₁₀ is slightly smaller than the inside diameter of a bore in the housing part 6. This bore in the housing part 6 is designated the secondary control pressure chamber 11. The additional hydraulically active surface area A₁₀ of this second step 10 is a circular ring with the outer diameter D₁₀ and the inner diameter D₈.

It is essential to the invention that the primary control pressure chamber 7 and the secondary control pressure chamber 11 are connected by a connection 12 with a throttle point 13, which is indicated schematically in FIG. 1. What is not essential is whether this primary control pressure chamber 7 and the secondary control pressure chamber 11 are formed by bores in a housing part 6 or whether they are realized in some other way. An alternative exemplary embodiment will be presented further below. The only point essential to the invention is that the hydraulic drive 3 has the primary control pressure chamber 7 and the secondary control pressure chamber 11.

In the following description of the function of the device, it is assumed that the system is in a state of equilibrium, in which, as a result of a certain control pressure P_{X}, the control piston 5 has taken up a certain position. A state of equilibrium also means that the control pressure P_{X} is present both in the primary control pressure chamber 7 and in the secondary control pressure chamber 11, because the pressure has become equalized through the connection 12 containing the throttle point 13. When the control pressure P_{X} is now increased, the force acting on the end surface A₈ also increases, which causes the control piston 5 to move toward the right against the control spring 9. At this moment, however, the higher control pressure P_{X} is present only in the primary control pressure chamber 7. Because of the throttle point 13, the pressure in the secondary control pressure chamber 11 cannot increase immediately. On the contrary, when the higher control pressure P_{X} in the primary control pressure chamber 7 causes the control piston 5 to move toward the right, the pressure in the secondary control pressure chamber 11 will fall, which opposes the movement of the control piston 5 toward the right. Only after hydraulic oil has been able to flow from the primary control pressure chamber 7 into the secondary control pressure chamber 11 through the connection 12 with the throttle point 13 will this pressure drop be compensated, and only after the arrival of additional hydraulic oil will it finally be achieved that the pressure in the secondary control pressure chamber 11 is exactly the same as the control pressure P_{X} also present in the primary control pressure chamber 7. Thus a state of equilibrium is reached again, in which the control piston 5 has now taken up a new position corresponding to the higher control pressure P_{X}.

During the first moment, therefore, a higher control pressure P_{X} acts only on the smaller end surface A₈. Only after the pressure has equalized across the throttle point 13 does the higher control pressure P_{X} act also on the hydraulically active surface of the second step 10 and therefore also on the surface area A₁₀, which is derived directly from the diameter D₁₀. It follows from this that there is a certain delay in the movement of the control piston 5 or that this movement is damped. As a result, the task of the invention is accomplished in a surprisingly simple way, for, as a result of this damping, the valve 1 has become insensitive to internally or externally induced oscillations, without any impairment to its response sensitivity, which could not be excluded in the case of the metering valve according to WO 97/32136 A.

The diameter D₈ can be, for example, 14 mm; the diameter D₁₀ can be 20 mm. The hydraulically active surface areas A₈ and A₁₀ will then be 153.9 and 314.2 mm , respectively, which results in an area ratio of 1:2.04. This indicates how large the amplitude of the oscillations which can be leveled out can be.

The damping is similar when the control pressure P_{X} decreases. When the control pressure P_{X} is reduced, the pressure in the secondary control pressure chamber 11 can decrease slowly only as a result of the flow of hydraulic oil via the connection 12 with the throttle point 13 from the secondary control pressure chamber 11 to the primary control pressure chamber 7.

There is therefore no need for the measures described in WO 97/32136 A1 to prevent the excitation of oscillations, such as the use of a nozzle and a metering valve which can be adjusted by means of an adjusting spindle. In this sense the inventive solution is extremely simple. The need to select the size of the nozzle for the specific application and to install it is also eliminated, nor is there any need for the time-consuming work of adjusting the metering valve.

It is advantageous to use the first step 8 of the control piston 5 in conjunction with the associated bore in the housing part 6, which forms the primary control pressure chamber 7, as the connection 12 containing the throttle point 13. This is shown in FIG. 2. This diagram is not to drawn to scale for the sake of clarity. The primary control pressure chamber 7 has an inside diameter D₇. The first step 8 of the control piston 5, as already shown in FIG. 1, has an outside diameter D₈. Thus a ring-shaped gap 14 is present in between, the dimensions of which are defined by the inside diameter D₇ and the outside diameter D₈. When this ring-shaped gap 14 is used as the throttle point 13, a remarkable advantage is obtained. Whereas a nozzle used as a throttle point 13 can change its behavior over the course of time as a result of the deposition of suspended matter, which causes a change in the throttling action, the ring-shaped gap 14 is cleaned repeatedly of deposits of suspended manner by the movement of the control piston 5 during the operation of the valve 1 (FIG. 1). The throttling action thus remains constant.

Because the ring-shaped gap 14 is essential to the function of the device, the tolerances of the inside diameter D₇ and the outside diameter D₈ are very important. These tolerances are selected so that the ring-shaped gap 14 has a width of advantageously about 0.01-0.04 mm. To achieve this, it is possible under certain conditions to match the control piston 5 to the housing part 6 through the selection of compatible stock parts.

FIGS. 3a-3c show a hydraulic circuit with a consumer 20, which, in the example illustrated here, is a double-acting cylinder with a pressure space at the bottom of the piston and another pressure space on the piston rod side. It would also be possible, however, to operate a hydraulic motor as the consumer 20 instead of the double-acting cylinder. The hydraulic circuit is shown in three different operating states, namely, the neutral position in FIG. 3a, the load-raising mode in FIG. 3b, and the load-lowering mode in FIG. 3c. The individual elements of the hydraulic circuit which are present are the same in all cases. The hydraulic circuit is known in and of itself and is shown here because the inventive action of the inventive hydraulically controlled valve can be described clearly on the basis of this circuit.

A directional control valve 21 and a load-holding brake valve 22, which serve to control the consumer 20, are shown in all three FIGS. 3a-3c. The load-holding brake valve 22 can be of the design described in, for example, WO 97/32136 A1, but it is equipped with a hydraulic drive 3 designed in accordance with the invention. The directional control valve 21 can be one of the types described in WO 02/075162 A1, for example, but it is also equipped with hydraulic drives 3′ designed in accordance with the invention.

The hydraulic oil can be conveyed by a pump 24, driven by a motor 23, between the tank 25 and the consumer 20. The pump 24 has a first check valve 26 and a pressure-limiting valve 27 in the conventional manner. The flow of hydraulic oil is determined by the positions of the directional control valve 21 and of the load-holding brake valve 22. A second check valve 28 is installed in the line leading to the bottom pressure space of the consumer 20. This separate check valve 28 can be omitted if the load-holding brake valve 22 already has a check valve, which is designated in the diagram of the load-holding brake valve 22 by the reference symbol 28′.

The directional control valve 21 is controlled in the conventional manner through the actuation of its two drives 3′. If neither of the drives 3′ is actuated, that is, if a control pressure P_{St} is not being applied to either of them, the directional control valve 21 assumes the neutral position.

In the neutral position of the directional control valve 21 shown in FIG. 3a, the connection in the directional control valve 21 between the pump 24, the bottom pressure space of the consumer 20, the piston-side pressure space of the consumer, and the return flow to the tank 25 is open. This does not apply in general and is different in the case of, for example, the directional control valve according to WO 02/075162 A1. This is not important, however, with respect to the invention. For the present circuit, the only important point in terms of the correct control of the consumer 20 is that, in the neutral position, the load-holding brake valve 22 is closed, so that the consumer remains in its original position. That the load-holding brake valve 22 remains closed can be derived directly from the fact that the control pressure P_{X} (FIG. 1) is approximately the same as the pressure in the piston rod-side pressure space of the consumer 20, which for its own part is approximately the same as atmospheric pressure, because the connection to the tank 25 is open.

FIG. 3b shows the load-raising mode. This is reached by the actuation of one of the drives 3′ of the directional control valve 21 by a control pressure P_{St}. The slide piston of the directional control valve 21 is moved in such a way that hydraulic oil can flow from the pump 24 through the directional control valve 21 to the bottom pressure space of the consumer 20 and from the piston rod-side pressure space of the consumer 20 to the tank 25. The pump 24 therefore conveys hydraulic oil from the tank 25 to the bottom side of the consumer 20, where the first check valve 26 and the second check valve 28 or the check valve 28′ are automatically actuated by the pump pressure. Because the hydraulic oil is conveyed to the bottom pressure space of the consumer 20, hydraulic oil is simultaneously displaced from the piston rod-side pressure space of the consumer 20 and flows via the directional control valve 21 to the tank 25.

The load-holding brake valve 22 has no function here. This is related to the fact that the active control pressure P_{X} is very low, because the hydraulic oil flows from the piston rod-side of the consumer 20 to the pressureless tank 25, as explained in connection with the neutral position. Thus the oscillation-damping action of the drive 3 of the load-holding brake valve 22 also remains without effect.

If the drives 3′ of the directional control valve 21 are designed according to the invention, they will also produce a damping action, which is advantageous when the control pressure P_{St}, as is often the case, is derived from the load pressure at the consumer 20 or from the pump pressure. Variations in this load or pump pressure are therefore damped in the drive 3′ of the directional control valve. The advantageous action of this damping occurs when, in the load-raising mode, the consumer 20 or the device operated by it encounters an obstacle which causes the load pressure to change instantaneously.

FIG. 3c shows the load-lowering mode. Here the pump 24 conveys hydraulic oil to the piston rod-side pressure space of the consumer 20. This is achieved by the application of a control pressure P_{St} to the other drive 3′ of the directional control valve 21. As a result, the connection in the directional control valve 21 from the pump 24 to the piston rod-side pressure space of the consumer 20 is open, and the connection from the bottom pressure space of the consumer 20 to the tank 24 is also open. The control pressure P_{X} acting on the load-holding brake valve 22 is now high. It is determined by the pressure generated by the pump and the pressure loss across the directional control valve 21.

Because hydraulic oil is flowing to the piston rod-side space of the consumer 20, hydraulic oil is now forced to flow from the bottom pressure space of the consumer 20 to the tank 24. The second check valve 28, which is parallel to the load-holding brake valve 22, or the check valve 28′, however, is closed in this load situation. Hydraulic oil can therefore flow from the bottom pressure space of the consumer 20 only if the load-holding brake valve 22 is opened. This is done by the control pressure P_{X}, the value of which is based on the proportional adjustment of the directional control valve 21 by the control pressure P_{St}. The goal is thus achieved in the conventional manner that the hydraulic oil can leave the bottom pressure space of the consumer 20. The quantity leaving the consumer 20 is larger than the quantity simultaneously entering the piston rod-side pressure space, because the cross section on the piston rod side is different from that on the bottom side.

In this operating mode, the inventive effect of the design of the drive 3 of the load-holding brake valve 22 comes into play. If the control pressure P_{St} is increased very quickly, the control pressure P_{X} also rises very quickly. The rapid increase in the control pressure P_{St} could cause oscillations in the consumer 20, but this oscillation is strongly damped by the inventive design of the drive 3 of the load-holding brake valve 22.

If the drives 3′ of the directional control valve 21 are designed as intended by the invention, the valve has a damping effect with respect to the action of the control pressure P_{St} on the directional control valve 21, which has the result that, in this way, too, the tendency for oscillations to occur in the consumer 20 are eliminated. It is thus impossible for a rapid increase in the control pressure P_{St} to cause oscillations in the consumer 20. Oscillations which are excited by alternating loads on the consumer 20, however, are damped simultaneously by the drive 3 of the load-holding brake valve 22.

This example shows that the inventive design of the drive 3 for the load-holding brake valve 22 can prevent oscillations during load-lowering mode. If the inventive design, which was originally intended only for use in a load-holding brake valve 22, is also used for the hydraulic drives 3′ of the directional control valve 21, additional effective damping is obtained as a result. It is therefore advantageous for the drives 3′ of the directional control valve 21 also to be designed in accordance with the principle of the invention.

FIG. 4 shows an advantageous embodiment of a drive 3, which can be used in a load-holding brake valve 22 (FIGS. 3a-3c). FIG. 4 is the same as FIG. 1 except that it also contains this advantageous embodiment. This consists in that a pressure relief check valve 30 is installed between the primary control pressure chamber 7 and the secondary control pressure chamber 11. This makes it possible for the pressure to be released from the secondary control pressure chamber 11 to the primary control pressure chamber 7. The pressure difference at which the pressure relief check valve 30 opens is determined by a spring 31.

This pressure relief check valve 30 has the effect described below. If the control pressure P_{X} is reduced, as already mentioned above, the control spring 9 has the effect of moving the control piston 5 toward the left. The pressure in the secondary control pressure chamber 11 cannot fall immediately, however. The pressure drop cannot occur until the connection 12 containing the throttle point 13 becomes effective. As previously mentioned, however, the load-holding brake valve 22 does not have any effect in the load-raising state according to FIG. 3b. There is therefore no point in allowing the drive 3 designed in accordance with the invention to produce a damping effect in this operating situation. The pressure relief check valve 30 accomplishes this.

FIG. 5 is basically similar to FIG. 4, except that it shows the ring-shaped gap 14 instead of the connection 12 with the throttle point 13. Here an additional advantageous embodiment is illustrated, in which a longitudinal groove 33 is cut into the cylindrical lateral surface of the first step 8 at the end facing the secondary control pressure chamber 11. As a result of this measure, the effective length of the ring-shaped gap 14 is limited; the flow of hydraulic oil between the primary control pressure chamber 7 and the secondary control pressure chamber 11 is facilitated; and thus the action of the damping is limited. In this way, the damping action of a valve 1 can be very easily adapted to the concrete application by adjusting the length of the longitudinal groove 33 to suit the circumstances.

FIG. 6 shows another advantageous embodiment of a drive 3 which can be used in a load-holding brake valve 22 (FIGS. 3a-3c). Here the pressure relief check valve 30 shown in FIGS. 4 and 5 is integrated directly into the drive 3. Only the parts important to the function of the inventive device are shown; the parts which, for example, serve to transmit force to the flow control device 2 to be actuated (FIG. 1) and the control spring 9 (FIG. 1) have been omitted.

What is shown is the control piston 5 with its first step 8 and its second step 10, which, as previously explained, have the diameters D₈ and D₁₀, respectively. Also shown are the primary control pressure chamber 7 and the secondary control pressure chamber 11. In contrast to FIG. 5, the pressure relief check valve 30 in this exemplary embodiment is located inside the hydraulic drive 3. In contrast to the device explained on the basis of FIGS. 1, 4, and 5, the hydraulic drive 3 does not have a separate housing part 6. Instead, the hydraulic drive 3 is located inside the housing of the valve to be controlled (FIG. 1), this housing being designated by the reference number 40 in FIG. 6. A cover 41 can be screwed into the housing 40, which is open toward the left. An opening is present in this cover 41; this opening represents the control pressure connection X, which, as also in the previous exemplary embodiments, is connected to the primary control pressure chamber 7.

It is advantageous here to install an orifice 42 between the control pressure connection X and the primary control pressure chamber 7, namely, inside the cover 41. This orifice has the effect of limiting the flow, which means in turn that, when the control pressure P_{X} increases very quickly, the increase in the pressure in the primary control pressure chamber 7 is delayed. Because this delay of the pressure increase implies a damping effect, an additional advantageous measure is obtained in terms of solving the problem in question.

Because the inventive damping occurs by way of the throttle point 13 (FIG. 1) or the ring-shaped gap 14 and because the damping by the orifice 42 is a supplemental effect, it is advantageous for the damping by the orifice 42 to be much smaller than the damping by the throttle point 13 (FIG. 1) or the ring-shaped gap 14. It has been found that an optimal effect is obtained when, for example, the dimensions of the ring-shaped gap 14 are calculated in such a way that the gap corresponds to a nozzle with a diameter of 0.1 mm, whereas the orifice 42 corresponds to a nozzle with a diameter of 0.3-0.6 mm. At a diameter ratio of 1:3-1:6, an area ratio of 1:9-1:36 is obtained. This clearly shows that the damping by the throttle point 13 (FIG. 1) or by the ring-shaped gap 14 is dominant. The orifice 42 provides an additional improvement.

The pressure relief check valve 30 integrated into the hydraulic drive 3 is formed by a check disk 45, which seals a seating surface 44. This disk is pressed by the spring 31, already shown in FIGS. 4 and 5, against the seating surface 44. The check disk 45 has a central bore 46. Inside the bore 46 is the part of the control piston 5 which forms the first step 8. The ring-shaped gap 14 is thus limited on one side by this bore 46 and on the other side by the diameter D₈ of the first step 8 of the control piston 5. The rules mentioned above can also be used to calculate the dimensions of the ring-shaped gap 14. The function of this pressure relief check valve 30 has already been described above. The closed position is shown in FIG. 6. The pressure relief check valve 30 opens when the control pressure P_{X} is reduced, as already described in conjunction with FIG. 4. The check disk 45 moves toward the left against the force of the spring 31 and therefore rises from the seating surface 44. Thus hydraulic oil can flow directly from the secondary control pressure chamber 11 into the primary control pressure chamber 7.

As shown in FIG. 5, the pressure relief check valve 30 is connected in parallel to the ring-shaped gap 14 between the primary control pressure chamber 7 and the secondary control pressure chamber 11. This is also true in the exemplary embodiment according to FIG. 6. The design according to FIG. 6 results in an advantageously compact unit.

The invention can be applied to all types of hydraulically controlled valves I in which oscillations might occur because of the way in which the system is controlled and/or the way in which the device such as a crane or front end loader is operated by the consumer 20.

1-10. (canceled)

11. A hydraulically controlled valve comprising a flow control device for controlling a flow of hydraulic oil to and from a consumer and a hydraulic drive, said hydraulic drive comprising:
a housing part defining a primary control pressure chamber, a secondary control pressure chamber and a control pressure connection connected directly to said primary control pressure chamber;
a control plunger connected to a control piston, said control plunger acting on said flow control device for controlling the flow of hydraulic oil, said control piston being a stepped piston having a first step and a second step, said first having a first diameter and a first end surface having a first area, said second step having a second diameter and a second hydraulically active end surface, the first end surface being subject to pressure in said primary control pressure chamber and said second end surface being subject to pressure in said secondary control pressure chamber;
a control spring acting on said control piston, said control piston being movable in said housing part against an urgency of said control spring in response to a control pressure present at said control pressure connection; and
a connection including a throttle point provided between said primary control chamber and said secondary control chamber.

12. The hydraulically controlled valve of claim 11, wherein said connection including said throttle point is formed by a ring-shaped gap defined between an inside diameter of said primary control pressure chamber and said first diameter of said first step of said control piston.

13. The hydraulically controlled valve of claim 12, wherein said ring-shaped gap has a width within the range 0.01-0.04 mm.

14. The hydraulically controlled valve of claim 12, wherein said hydraulically controlled valve is a load-holding brake valve.

15. The hydraulically controlled valve of claim 12, wherein said hydraulically controlled valve is a directional control valve.

16. The hydraulically controlled valve of claim 14, further comprising a pressure relief check valve installed between said primary control pressure chamber and said secondary control pressure chamber arranged and dimensioned for releasing pressure from said secondary control pressure chamber to said primary control pressure chamber.

17. The hydraulically controlled valve of claim 16, further comprising a spring defining a pressure difference at which said pressure relief check valve opens.

18. The hydraulically controlled valve of claim 12, further comprising a longitudinal groove cut into a cylindrical lateral surface of said first step at an end of said first step facing said secondary control pressure chamber.

19. The hydraulically controlled valve of claim 16, wherein said pressure relief check valve is arranged inside said hydraulic drive between said primary control pressure chamber and said secondary control pressure chamber.

20. The hydraulically controlled valve of claim 19, further comprising a restricting orifice installed between said control pressure connection and said primary control pressure chamber.

21. The hydraulically controlled valve of claim 20, wherein said throttle opening produces a first damping effect on the movement of said control piston and said restricting orifice produces a second damping effect, said first damping effect being larger than said second damping effect.

22. The hydraulically controlled valve of claim 1, wherein said pressure in said secondary control chamber is equalized with the pressure in said primary control chamber through said connection including said throttle point such that said throttle point produces a damping effecting on the movement of said control piston.
